(19) United States
(12) Patent Application Publication
(10) Pub. No.: US 2007/0209526 A1
(43) Pub. Date: Sep. 13, 2007

(54) Machine for the Production of Multilayer Food Products

(76) Inventor: Stefano Visona, Schio (IT)

Correspondence Address: BROWDY AND NEIMARK, P.L.L.C.;624 NINTH STREET, NW, SUITE 300, WASHINGTON, DC, 20001-5303, US

(21) Appl. No.: 10/574,483

(22) PCT Filed: Sep. 15, 2004
(86) PCT No.: PCT/IT04/00497

§ 371 Date: Nov. 14, 2006

(30) Foreign Application Priority Data
Oct. 3, 2003 (IT) PD2003A000231

(51) Int. Cl. A23P 1/00

(52) U.S. Cl. 99/450.1

(57) ABSTRACT

Machine for the production of multilayer food products, in particular for the production of multilayer cakes, provided with a rotating platform (3) having, associated therewith, four operating stations (A, B, C, D) able to operate in sequence on the food product and arranged at 90 DEG with respect to each other and preferably composed of: a station (A) for loading different layers of pastry (5); a first dispensing station (B) for distributing a liquid filling product; a second dispensing station (C) for distributing a fairly dense filling product such as a cream or the like; and a station (D) for expelling the cake (T) once completed.

The present invention relates to a machine for the production of multilayer food products, and in particular for the production of cakes comprising several layers of pastry. In greater detail, the machine in question is intended to be used in the sector of the food industry in processes for the production of cakes where it is required to obtain from layers of pastry a final product comprising several layers assembled on top of each other with layers of dressing or filling arranged in between.

Traditionally it is known to assemble in an entirely manual manner the different layers of pastry with the appropriate layers of filling arranged in between. Obviously, this system has notable limitations with regard to productivity and constancy in the quality of the product which can be obtained.

In order to overcome this drawbacks, plants of a known type have been developed, said plants being able to assemble layers of pastry in an entirely automatic manner, arranging between them the desired fillings. These plants generally use several stations which are arranged in line with each other and which perform by means of special operating units the operations of filling and arrangement, on top of one another, of the layers of pastry in sequence with each other. Therefore, in accordance with these embodiments of plants, the individual units operate, always having as a reference point, a predefined height of the product which is to be processed.

Obviously, this height may be subject to adjustment also with a view to preparing a different production cycle with different food products.

The plants designed in accordance with the art known hitherto have, however, certain major drawbacks.

Firstly, these plants for the production of multilayer cakes have a construction cost which is somewhat high due mainly to the fact of having to provide a separate operating unit for each individual step in the process for production of the multilayer product to be made. In other words, for example, in order to fill a cake with different layers, it is required to provide two different machines for the filling, able to distribute two fillings at different heights.

This fact, if on the one hand it ensures a greater productivity of the plant, on the other hand results in an increase in the construction cost thereof.

A further drawback of the present plants for the production of multilayer cakes consists in their excessively large volume, which means that they may be used only in relatively large premises.

Finally, another drawback of these plants consists in the considerable amount of time required to clean all the individual stations which are provided along the production line.

The main object of the present invention is therefore that of overcoming the drawbacks associated with the machines of the known type by providing a machine for the production of multilayer food products, in particular for the production of multilayer cakes, which can be manufactured at a low cost.

Another object of the present invention is that of providing a machine for the production of multilayer food products, which has limited dimensions.

Another object of the present invention is that of providing a machine for the production of multilayer food products which is extremely versatile and which allows the production of different types of cakes.

A further object of the present invention is that of providing a machine for the production of multilayer food products which is constructionally simple and operationally entirely reliable.

The technical features of the invention, together with the abovementioned objects, may be clearly understood from the contents of the claims appended below and the advantages thereof will emerge more clearly form the detailed description which follows, with reference to the accompanying drawings which shows a purely exemplary and non-limiting embodiment thereof in which:

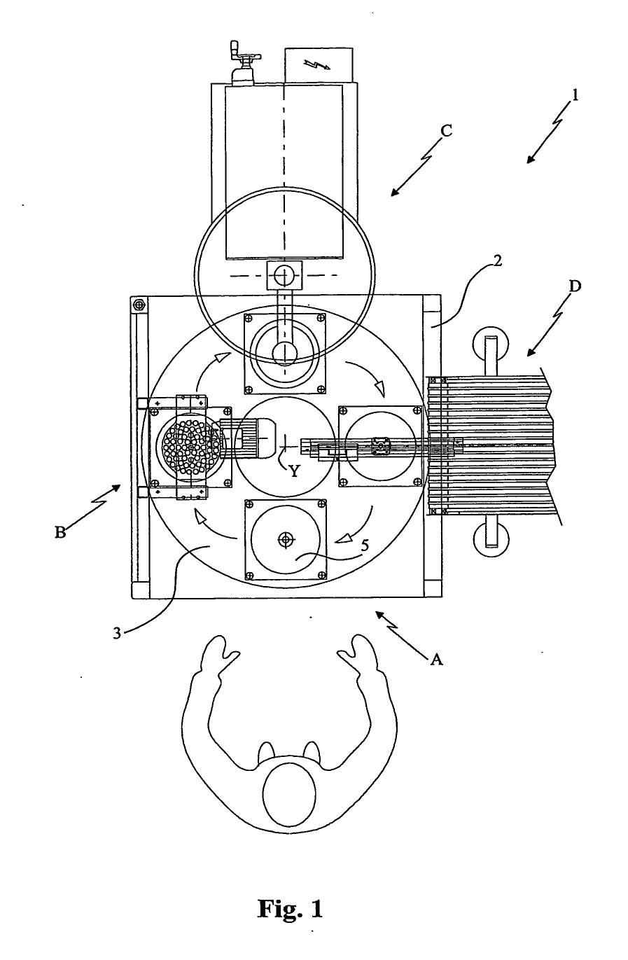

FIG. 1 shows a schematic plan view of the machine for the production of multilayer food products according to the present invention;

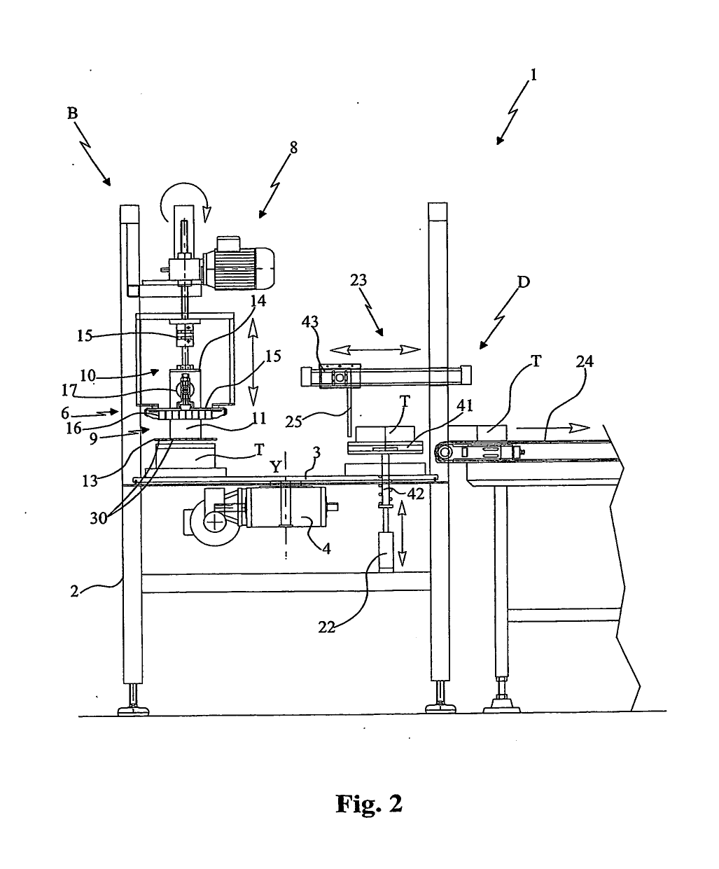

FIG. 2 shows a first schematic side view of the machine according to FIG. 1 with some parts removed so that other parts may be seen more clearly;

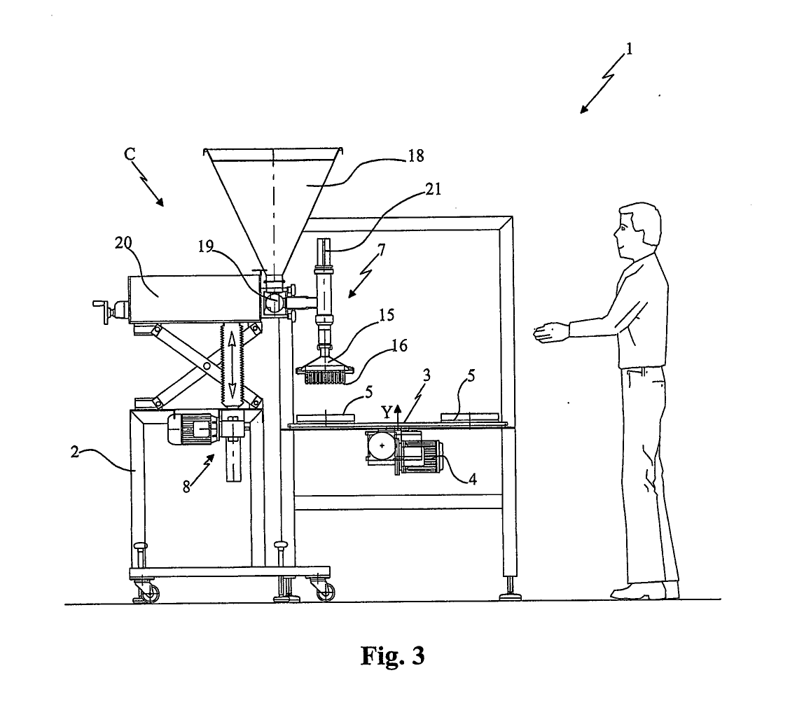

FIG. 3 shows a second side view of the machine according to FIG. 1 with other parts removed so that even more other parts may be seen more clearly.

In accordance with the figures of the accompanying drawings, 1 denotes in its entirety the machine for the production of multilayer food products in question.

In accordance with a preferred embodiment of the present invention, the machine 1 is intended in particular for the production of multilayer cakes (T) of the type for example formed by arranging on top of one another, or assembling together, individual layers of pastry, for example meringue sponge cake or other ingredient, with in between layers of filling such as pastry cream, chocolate, milk cream, liqueur or some other filling.

The machine 1 may advantageously be mounted operationally inside a more complex production plant which envisages the arrangement in line, upstream and downstream, of additional machines or units for carrying out additional operating steps.

In greater detail, the machine may be incorporated within an industrial plant and arranged, for example, downstream of an oven for the production of layers of pastry and upstream of a filling unit intended to spread a glazed coating, a layer of cream or similar products over all or part of the external surface of the cake, this latter unit in turn being followed in sequence for example by a unit for distributing a product in granular form over the side surface of the cake.

The machine for assembling the layers, the machine for spreading the coating of cream and the machine for distributing the granular product may be advantageously mounted as separate units on a same more complex machine provided with transportation means for transferring the cakes from one unit to another.

With reference to the figures of the accompanying drawings, the machine 1 comprises a support structure 2 formed by a plurality of support columns which are connected together by horizontal cross-members and at the bottom rest on the ground by means of support feet with an adjustable height.

The support structure 2 comprises a quadrangular frame which has four columns at its corners and centrally supports in a rotatable manner a rotating platform 3 with a vertical axis Y which is mechanically connected to rotation means 4 via mechanical transmission devices of a type known per se. These means 4 advantageously consist of an electric motor which is mounted fixed onto the support structure 2 underneath the rotating platform 3.

The rotating platform 3 has a substantially circular shape on which it is possible to define different sectors with which different operating stations are operationally associated.

In accordance with a preferred embodiment of the present invention, four stations are envisaged, said stations being associated with diametrically opposite sectors of the rotating platform 3 and separated from each other at intervals of 90°.

In more detail the following are envisaged: a station A for loading different layers of pastry 5; a first and a second dispensing station—denoted by B and C respectively—each of which is provided with a distribution unit 6 and 7, respectively, for spreading a different filling product; and a station D for expelling the cake T once it has been completely formed.

According to an important characteristic feature of the present invention, first movement means 8 are also envisaged, said means being able to displace said distribution unit or a surface supporting the cake T between different operating heights corresponding to different heights of the cake T being formed. In this way, each distribution unit B and C may intervene cyclically several times on a same cake T, distributing the filling over different layers of pastry 5 from a predefined optimum height.

Functionally speaking, therefore, a first layer of pastry 5 is for example initially deposited manually or by means of an automatic feeding system on the sector of the platform 3 corresponding to the loading station A, the platform is then rotated through 90° so that the first layer of pastry 5 reaches the first dispensing station B where the first distribution unit 6 releases a filling product (wet dressing). Then the wet pastry 5 proceeds to the second distribution station C following a further rotation of the platform 3 through 90° so as to receive a second filling product from the distribution unit 7 of this latter station C. At this point the layer of pastry 5 thus filled is subject to at least one further filling cycle, being made to pass through the unloading station D until, following a rotation of the platform 3 through 180°, the loading station A is reached again for the arrangement of a second layer of pastry on top of the first layer of pastry 5. The platform 3 then continues its rotation in successive steps of 90°, causing the two superimposed layers of pastry 5 to pass again through the two filling stations B and C. Initially, the distribution units 6, 7 of the abovementioned filling stations B and C will be specifically positioned at an operating height which is higher than the previous height and takes into account the deposition of the second layer of pastry 5 and filling performed on the first layer. In order to allow the distribution units 6 and 7 to deposit the filling product onto the—in this case second—layer envisaged it is indispensable for them to be situated at a suitable and preferably constant distance from the top of the cake being formed. Once the second cycle has also been completed, the cake T thus formed may be conveyed away from the machine 1 via the expulsion station D or may continue, for further assembly and filling cycles, through the stations A, B and C. In other words, each distribution unit 6, 7 is able to intervene cyclically several times on a same cake (T) being formed, taking into account the height reached by the latter which is determined by the number of layers of pastry 5 arranged on top of each other and the fillings arranged in between.

This operating sequence is favoured by the adjacent arrangement of the loading station A and expulsion station D.

In accordance with a further characteristic feature of the present invention, the first dispensing station B is intended to distribute a particularly liquid product (wet dressing) intended to soften the layer of pastry without thus substantially causing an increase in the height of the cake T.

Advantageously, as can be seen in particular in FIG. 2, compression means 9 are envisaged, said means being mounted on a first distribution unit B so as to compress the top surface of the cake T. This operation is particularly useful for pressing the layers of pastry 5 deposited on the previous layers and therefore may not be performed where a single layer of pastry 5 is present.

In greater detail, according to one possible embodiment, these means 9 comprise a movable framework 10 provided with two arms 11 having fixed thereto at the bottom a pressing surface 13 and being connected at the top by means of a cross-member 14 to a first actuator 15 which is in turn integral with the first distribution unit 6 so as to be moved integrally by the movement means 8.

Operationally speaking, the pressing surface 13 is displaced between a rest position, where it does not interfere with the cake T, and a compression position, where it compresses at the top the cake T with a predetermined force defined by the length of its stroke.

Both the distribution units 6 and 7 are provided with a head 15 having a plurality of nozzles 16 for delivering the respective filling product onto the upper surface of the cake T. The distance of the nozzles from the cake T is kept substantially unchanged for each filling cycle owing to the operation of the first movement means 8 between the different operating heights.

The first dispensing station B advantageously has a pressurised tank (not shown) for containing the filling liquid (wet dressing), which supplies the nozzles 16 via a pipe having, arranged along it, a valve 17 which opens in a synchronized manner so as to distribute the filling product over the cake T.

The pressing surface 13 is retained by the movable framework 10 underneath the head 15 and is provided with a plurality of holes 30 arranged aligned with the position of the nozzles 16 of the head 15 so as not to interfere with the distribution of the filling product (wet dressing).

The second dispensing station C is instead preferably intended to distribute a fairly dense filling product consisting for example of pastry cream, milk cream or the like.

For this purpose it is envisaged using a hopper 18 for loading the product, which communicates by means of a three-way valve 19 with a compression cylinder 20 which is charged with a quantity of product corresponding to a predefined and adjustable volume thereof. At this point, the three-way valve 19 is switched over so as to connect the cylinder 20 to the distribution head 15 and then the piston of the cylinder 20 is actuated with a linear movement by suitable motor means (not shown) so as to as to spread the cream over the top surface of the cake T.

In order to allow better distribution of the cream over the cake (T) by the head 15 of the second distribution unit 7 of the second dispensing station C, it is necessary to ensure that distribution is performed with the nozzles 16 positioned closed to the layer of pastry 5 to be filled and, once distribution has been completed, that the nozzles 16 are moved away from the layer of pastry so as to ensure their complete separation from the upper surface of the pastry and interruption of any surplus filaments of cream.

For this purpose, second movement means 21 are envisaged, said means being mechanically connected to the head 15 of the second distribution unit 7 so as to move the latter between a lowered distribution position, where the head 15 is positioned with its nozzles 16 at a predefined distance from the cake T, and a raised rest position, where the head 15 is situated at a greater distance from the cake T so as to interrupt any filaments of cream connected to the cake T.

In accordance with a variation of embodiment of the present invention, not shown in detail in the accompanying figures in that it is within the grasp of any person skilled in the art, the second distribution unit 7 may have two separate distribution heads which are supplied with two different filling products (for example pastry cream and chocolate or chocolate and milk cream) and are operated alternately depending on the filling product to be distributed.

Obviously, simple movement means may be envisaged for moving into the operating position the head 15 which has been prechosen for delivery of a given filling product.

Once the cake T has performed the required number of cycles and therefore is assembled with the predefined number of layers of pastry 5 having the appropriate layers of filling product in between, it is necessary for the cake to be expelled from the machine at the expulsion station D so as to make way for a new cake being formed.

For this purpose, the last station D comprises a support base 41 which is mounted on top of a shaft 42 which can be raised or lowered by a second linear actuator 22. In so doing, the support base 21 may be displaced between a bottom position, where it receives the cake T from the rotating platform 3, and an upper position where it allows the pusher means 23, comprising a third actuator 43, to push the cake T onto a conveyor belt 24 so as to move it away from the machine 1.

In greater detail, the pusher means 23 comprise a vertical engaging arm 25 movable horizontally between two different positions, one opposite the machine 1 and the other opposite the conveyor belt 24, as clearly shown in FIG. 2.

As has been clearly described above, the first movement means 8 perform the task of arranging the heads 15 of the distribution units 6 and 7 at a suitable relative—if necessary constant—distance D from the last layer of pastry 5 of the cake T which is being formed.

In order to achieve this, said means must displace the distribution means 6, 7 or a suitable surface supporting the cake T, so as to restore the abovementioned distance between the head 15 and the top of the cake T whenever a further layer 5 has been added to the latter.

The possibility of adjusting the relative distance between the heads 15 and the upper layer of the cake T by means of the movement means 8 allows the distribution units 6 and 7 (together or individually) to intervene cyclically several times on the same cake T, distributing the wet dressing or cream filling over all the different layers of pastry 5 which form the cake, operating at a suitable distance. The said relative distance for distribution of the wet dressing or cream may be defined or optimized, for example by means of a logic control unit, for each layer of the cake, or for each type of cake, or also may be kept constant for all the layers of the cake T.

The abovementioned movement means 8 consist, for example, as indicated in the accompanying drawings, of a motor engaged with a threaded vertical shaft able to raise or lower each distribution unit 6 and 7.

These same movement means 8 may, however, be formed by any other movement mechanism suitable for allowing the relative movement of the distribution means or the cake support surface, without thereby departing from the scope of protection of the present patent.

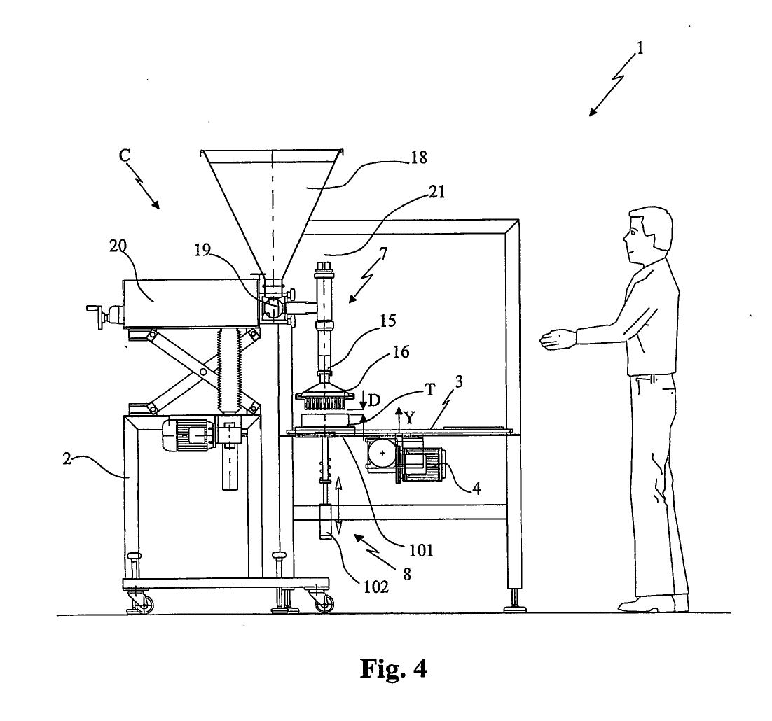

In particular, for the purposes of the present invention, it is possible to envisage adopting a mechanical solution which is entirely equivalent to the one described above and schematically shown in FIG. 4 and which envisages performing a controlled displacement of the surface supporting the cake T, instead of the distribution means 6, 7, so as to obtain in a similar manner control of the abovementioned relative distance.

In this case, these movement means 8 may comprise for example a linear actuator 102 able to displace in a controlled manner (for example by means of a PLC) the support surface 101 being raised or lowered, so as to move the cake T depending on the height which it reaches with the variation in the number of layers of pastry 5 and filling which have been previously arranged on top of each other.

In any case preferably, the movement of the platform 3, the operation of the first and second movement means 8 and 21 as well as that of the actuators 15, 21, 43 and the valves 17, 19 is controlled by a logic control unit in accordance with programmable operating steps.

The three linear actuators 15, 21 and 43 preferably consist of pneumatic pistons.

The invention this conceived therefore achieves the predefined objects.

Obviously, it may also assume, in its practical embodiment, forms and configurations different from that illustrated above without thereby departing from the present scope of protection. Moreover, all the details may be replaced by technically equivalent elements and the forms, the dimensions and the material used may be of any nature in accordance with the requirements.

1. Machine for the production of multilayer food products, in particular for the production of multilayer cakes or similar products, characterized in that it comprises:
a support structure constrained to the floor;
a rotating platform with a substantially vertical axis Y, mounted on said support structure;
a plurality of operating stations able to operate in sequence on said food product and associated with different sectors of said rotating platform, said plurality comprising:
at least one station for loading different layers of pastry;
one or more dispensing stations, each provided with a unit for distributing a filling product; at least one station for expelling the food product formed;
first movement means able to displace said distribution unit or a surface supporting said food product between different heights of said food product, said distribution unit being thus able to intervene cyclically several times on a same food product from a predetermined height.

2. Machine according to claim 1, characterized in that it comprises at least one first and one second dispensing station with corresponding first and second units for distributing a same or different filling products.

3. Machine according to claim 1, characterized in that said stations are four in number and are associated with sectors of said rotating platform spaced from one another at intervals Of 90°.

4. Machine according to claim 1, characterized in that said loading and expulsion stations are arranged on adjacent sectors.

5. Machine according to claim 1 characterized in that said first dispensing station comprises compression means mounted on said first distribution unit and able to expert a pressure on the upper surface of the food product.

6. Machine according to claim 5, characterized in that said compression means comprise a movable framework supporting at the bottom a pressing surface which can be actuated by a first actuator mounted on said first distribution unit between a rest position, where said pressing surface does not interfere with the food product, and a compression position where said pressing surface compresses said product with a predetermined force.

7. Machine according to claim 1, characterized in that each distribution unit is provided with a head having a plurality of nozzles for delivering said filling product onto said food product at a predetermined distance from the latter which is reached by means of operation of said first means for performing movement between said different operating heights.

8. Machine according to claim 6, characterized in that said pressing surface is mounted on said first distribution unit underneath said head and is provided with a plurality of holes arranged opposite said nozzles.

9. Machine according to claim 7, characterized in that said second distribution unit of said second dispensing station is provided with second movement means mechanically connected to said head so as to displace the latter between a lowered distribution position, where said head is positioned at a predefined distance from said food product, and a raised rest position, where said head is situated at a greater distance from said food product and where delivery of the filling product is interrupted.

10. Machine according to claim 1, characterized in that said first distribution unit is intended to spread a liquid product over said food product.

11. Machine according to claim 1, characterized in that said second distribution unit is intended to spread a creamy product over said food product.

12. Machine according to claim 9, characterized in that said distribution unit is provided with two separate heads supplied with two different filling products and intended to be operated alternately depending on the filling product to be distributed.

13. Machine according to claim 1, characterized in that said expulsion station is provided with a support base which is actuated by a second actuator so to be displaced between a bottom position where it receives said food product from said rotating platform and an upper position where, by means of pusher means, it directs said food product towards an exit opening.
